(19) United States
(12) Patent Application Publication
(10) Pub. No.: US 2006/0001594 A1
(43) Pub. Date: Jan. 5, 2006

(54) Apparatus and Method for Remotely Controlled Variable Message Display Systems Capable of Break-Apart Configurations

(76) Inventors: Brian T. Dantinne, Wauwatosa, WI (US); Daniel W. Nitzsche, Pewaukee, WI (US)

Correspondence Address: MARJORY S. STEWART LAW OFFICE, 611 NORTH BROADWAY, SUITE 510, MILWAUKEE, WI, 53202, US

(21) Appl. No.: 10/907,642

(22) Filed: Apr. 8, 2005

Related U.S. Application Data
(60) Provisional application No. 60/584,037, filed on Jul. 1, 2004.

(51) Int. Cl. G09G 5/00

(52) U.S. Cl. 345/1.1

(57) ABSTRACT

An apparatus and method for remotely controlled variable message display systems comprising a plurality of display panels, each of which is independently capable of stand-alone operation; each said panel comprises a plurality of signal elements having an on state and an off state. A controller located remotely of the set of display panels produces an information signal which travels to all panels. Each display panel can be separated from the main sign and placed at separate locations, away from a controller. A logic circuit is associated with each display panel. A data bus interconnects the controller and the logic circuit whereby the alpha-numeric or image data and the panel location data are communicated. A data bus allows for wireless connection to each display panel.

### FIELD OF INVENTION

The present invention relates to alpha-numeric and graphic display systems, wherein display systems can be changed by remote control wireless systems. More particularly, the invention relates to an alpha-numeric and graphic display systems using Liquid Crystal Display (LCD) technology, which uses less energy, and allows for rapid and safe manipulation of signage.

### BACKGROUND OF THE INVENTION

Graphical display units have immense applications in daily life ranging from in-house utilities like television, phones, and computers to the off-road banners, direction indicators signals, advertisements, office notices boards etc. LCD technology has been used since the mid 1970's when it was first introduced for an application in a sports wrist watch. Until 2000, the technology has been limited to indoor use. However, the demand for LCD screens with laptops prompted technological improvements that led to outdoor capabilities.

Other electronic variable message display systems, using technology such as high output light emitting diodes (LEDs), have found many applications since their emergence in the late 1990s for applications such as traffic control signals, and message display systems. The LED technology replaces the incandescent lamp technology of prior message display systems. LED systems are in widespread use because they are easy to fabricate and operate.

Another system is a manual plastic variable message display system, which requires manual switching of plastic letters into backlit display areas. With this system comes considerable risk and liability as workers are frequently injured during sign changes, and wind storms occasionally cause plastic letters to become dislodged from their architectural placements.

Technologies employed by various display units for uses described above and other purposes are found in the following patents.

U.S. Pat. No. 2,986,982, by Kaprelian, discloses a pair of spaced glass plates. A center opening is connected by a tube to a pump in order to move opaque fluid from a tank. In the normal pumping condition, light cannot pass through the fluid. To open, the pump sends air through the tube which clears the tube and allows light to pass through the tube.

U.S. Pat. No. 4,627,182, by Weiss, provides a two-sided display element that may be rotated by the force of voltage applied to a crystal. A display device for use in constructing remote controlling billboards, bus destination signs, and the like has a two-sided display disc which is carried on a pivoted support. The display disc is rotated by the application of force from a piezoelectric crystal drive to a point on the support which is off of the axis of rotation of the support. The crystal drive responds to DC voltage of one polarity or the other to rotate the display disc to expose a dark side or a light side to the viewer.

U.S. Pat. No. 6,243,690, by Adamec, shows an electronic price label (EPL) which includes a plurality of separately-addressable displays.

U.S. Pat. No. 6,570,492, by Peratoner, discloses a distributed electronic price display system includes a central computer communicating through a radio frequency system to receivers located preferably at a gondola unit between each aisle in a facility to display prices or other information. Each gondola unit may be controlled by a single controller. Each level of control at the gondola redistributes information to the next level down by selectively enabling the receipt and re-transmission of the information at various routing points in the system, including master controllers, slave controllers, and price tag modules. This process continues until the message is loaded into the electronic display. A change of price can be accomplished remotely from the central station by the use of a radio frequency terminal carried by an attendant.

U.S. Pat. No. 4,063,377, by Hukill, shows a changeable display device comprising a two-dimensional array of rotatable display elements with flat sides of contrasting colors. The display elements are manipulated to selectively display one or the other of the contrasting colors. The display elements of the array thereby form a number which is surrounded by a contrasting color.

U.S. Pat. No. 4,796,370, by Chang, discloses a seven segment display wherein each segment has a transverse axle that may be rotated by a small electric motor. Each segment is operated by a transmission mechanical gear assembly and a low voltage direct current motor. Only a low energy solar cell or battery is required to operate all the segments so as to provide a selected numerical display.

U.S. Pat. No. 5,828,355, by Comeau, shows a general purpose liquid crystal display controller apparatus for controlling an LCD driver is operable to control an LCD having a plurality of individually addressable pixels arranged in lines.

U.S. Pat. No. 5,825,341, by Pawlowski, discloses a control interface for LCD dot matrix displays, and a method for operating the same using a pair of controller/driver devices each having inputs for eight data bits but being adaptable to operate with four data bits from a 4-bit microprocessor. The control interface can interface to liquid crystal displays with less than 80 characters without microprocessor modification.

U.S. Pat. No. 6,624,757, by Johnson, shows a wireless communication link for LCD systems used in retail shelf pricing.

U.S. Pat. No. 5,751,257, by Sutherland, provides a programmable method for changing and updating indoor shelf tag information.

U.S. Pat. No. 4,164,824, by Nidelkoff, shows a sign having self-storing characters which are quickly changeable. The face of the sign has a patterned array of openings juxtaposed against a contrasting background. The background may be supplied by color contrast and/or by illumination.

U.S. Pat. No. 6,215,411, by Gothard, discloses a remotely controlled electronic display sign which operates with a plasma display and which provides for humidity control and the like allowing the sign to be used in various environments. The sign is essentially self-contained and includes those components necessary for enabling a display of desired material from a remote control source.

U.S. Pat. No. 5,101,587, by Toraby-Payhan, shows a numeral display device having at least one visible face. Each segment of the device has a transparent outer pane and a spaced, parallel inner pane forming a pocket, a first portion of the pocket being aligned with and visible through an opening in the face. A flexible film is received in each pocket. A mechanism is provided to insert and withdraw each film from the first portion of each pocket so that each segment will either contrast with or match the face.

U.S. Pat. No. 4,024,532, by Sherwin, discloses a reflective type module for remotely controlled sign displays providing a plurality of linear elements adapted for form the Latin alphabet and Arabic numerals, each element controlled by a two position electromechanical motor to be rotatably moved to a visual or non-visual state in response to an electrical signal. Each module is self-contained and individually encased.

U.S. Pat. No. 6,088,008, by Reeder, discloses remote operation of LCD interchangeable character display systems by way of a wired data bus controller and logic circuits. The problem encountered in U.S. Pat. No. 6,088,008 that is overcome by the present invention is that the system relies on individually addressable display elements.

All of the above and many others provide different type of display systems but none of these patents teach, suggest, or disclose a variable message display system that is energy-efficient and remotely controlled with panel-specific addressing features, with economical design and having individual display panels that are easily changeable. Therefore it has been observed that there is a need for a system with all these features and which accomplishes a comprehensive solution to above issues.

### OBJECT AND SUMMARY OF THE INVENTION

Therefore, it is an object of the invention to overcome the above and other drawbacks of the existing art.

It is another object of the invention to provide an apparatus and method for remotely controlled variable message display systems that is an energy-efficient display system.

It is yet another object of the invention to provide an apparatus and method for remotely controlled display systems.

It is a further object of the invention to provide an apparatus and method for variable message display systems.

It is yet a further object of the invention to provide an apparatus and method for remotely controlled variable message display systems which is cost effective.

It is another further object of the invention to provide an apparatus and method for remotely controlled variable message display systems that has economical addressing design.

It is an additional object of the invention to provide an apparatus and method for remotely controlled variable message display systems that has individual display panels.

It is an additional object of the invention to provide an apparatus and method for remotely controlled variable message display systems that has individual display panels which are easily changeable.

It is yet an additional object of the invention to provide a solution which meets all above objects and is independent of the size of the display system.

Compartmentalizing each device of hardware into discrete units serves to abstract each layer into four primary components: sign panel, sign panel controller, bus controller, and user interface.

To achieve the above objectives the invention provides a method which allows a user to enter data through a user interface which transmits properly encoded data to an addressed bus controller. After confirming packet data validity, the bus controller parses the data and then encodes new packets to be sent in turn to individual sign panels. Each sign panel receiving a packet also confirms packet data validity.

By incorporating logic circuitry and non-volatile memory into each display panel, dedicated hardware for addressing individual sign panel elements is eliminated which reduces the complexity, initial cost, and maintenance cost associated with interconnecting cables containing a large number of discrete wires.

Each sign panel being able to operate autonomously provides added functionality. The system may operate as a stand-alone display independent of a controller and each display panel is a programmable to display a preset routine. The system according to the invention may be provided with a provision such that when power is applied to the system, display panel will display a preprogrammed routine without a controller or data bus.

By utilizing abstraction and a bus topology, the system may grow in size without the complexity or cost associated with dedicated addressing hardware.

Further more, the bus topology assure better system integrity by compartmentalizing hardware in discrete and environmentally sealed sections, utilizing a robust bus structure, and employing error checking. A damaged component is more easily diagnosed and can be quickly replaced.

By utilizing packet error checking after each transmission, the bus topology provides greater reliability than discrete wires as feedback is provided from both the bus controller and each individual sign panel regarding compromised data integrity.

The method further provides an array of display elements that may utilize liquid crystals, light emitting diodes, bi-stable technology and shutter elements in any combination.

The message display system has signal elements organized in rows and columns, which may include liquid crystals, light emitting diodes, bi-stable technology and shutter elements. Such a matrix provides for the display of alpha-numeric characters as well as graphic images.

### BRIEF DESCRIPTION OF DRAWINGS

The invention will now be described with reference to accompanying drawings.

FIG. 1 shows a general embodiment of the invention.

FIG. 2 shows a sign pole with four sign groups.

FIGS. 3 to 8 shows detailed circuit diagram according to one possible embodiment of the invention.

### DETAILED DESCRIPTION OF INVENTION

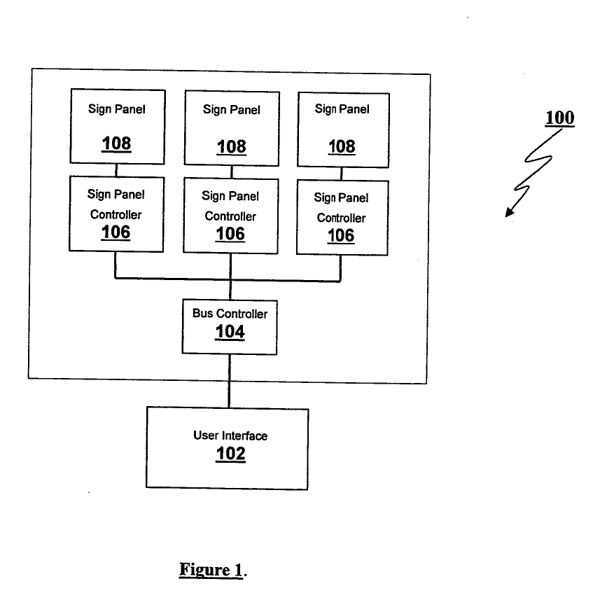

FIG. 1 shows a general embodiment of the invention 100. The display system according to the present invention comprises a user interface 102 for entering, encoding, and sending the desired display data to the bus controller/controllers 104. The user interface 102 can send data to bus controller 104 and its associated sign panel controllers 106, and/or multiple bus controllers 104 and their associated sign panel controllers 106. The bus controller 104 interprets the data received from the user interface 102 device and formats it for the desired sign panel controller 106.

The bus controller 104 sends the formatted data to the sign panel controller 106 via the data bus. The sign panel controller 106 is wirelessly or otherwise connected to the sign panels 108. These sign panels 108 display desired alphanumeric or graphical information. The sign panel 108 may contain various sign elements such as, LCDS, LEDs, mechanical shutters, bistable technology, serial data device, or various other display element technologies. Exemplary sign panels 108 are described in U.S. Pat. No. 6,088,008.

The operation of above display system 100 can operate in three modes namely; bus mode, break apart mode and stand alone mode. These modes of operation can be understood as follows. In the bus mode the user interface 102 is used to produce the desired characters or image data that will be displayed on each sign panel 108. The desired character or image data is sent to the bus controller 104 from the user interface 102. The methods used to send the character or image data to the bus controller can be radio frequency, opto-electronic, hardwired, telephone line, or other known data exchange technologies. The user interface 102 will format the desired character or image data into an appropriate packet, which will include one bus controller 104 address and one unique sign panel controller 106 address. The data are then sent from the user interface 102 to the desired bus controller 104, which will utilize error checking to prevent erroneous data. If there are erroneous data, the bus controller 104 will send a signal requesting data retransmission until non-corrupt data are received. The addressed bus controller 104 will then process and interpret the received data and assign an order to which sign panel controllers 106 will receive data first, second, third, etc.

The bus controller 104 will then send a data request command to the first sign panel controller 106. The data sent includes a data request command value and the sign panel controller's 106 address. The addressed sign panel controller 106 will then receive the bus controller's 106 data and check it for errors. If there are erroneous data, the sign panel controller 106 will request a data retransmission until the correct data format is received. The sign panel controller 106 will then process and interpret the received data and format the data according to the configuration of sign panel 108. The bus controller 104 will continue to send the character or image data to the appropriate sign panel controllers 106. After the bus controller 104 has sent all the necessary data, the bus controller 104 will then send a global display data command to all of the sign panel controllers 106. The global display data command requires all addressed sign controllers 106 to start sending the character or image data to the sign element 108. This method will allow the sign panels 108 to appear to be updated or changed simultaneously.

According to one embodiment of the invention, the sign panel 108 and its associated sign panel controller 106 can be separated from a sign containing several sign panels 108 and sign panel controllers 106 on a common bus, allowing a “break-apart” mode of operation. The common bus is implemented using a differential RS485 transceiver. The RS485 standard generally indicates a distance limit of the controller to the panel of about four thousand feet depending on data rate. The common bus is not limited to this method, which would allow the distance between individual sign panel 108, and sign panel controllers 106 to be greatly increased.

According to another embodiment of the invention, the sign panel 108 and sign panel controller 106 can be separated from the user interface 102 and the bus controller 104. This allows a stand-alone sign module to function with preprogrammed character or image data and display program. The sign panel controller 106 can incorporate a non-volatile memory that can be used to store character or image data and a pre-programmed set of display instructions. The sign panel controller 106 can be programmed to run a pre-programmed display routine and associated character or image data on power up.

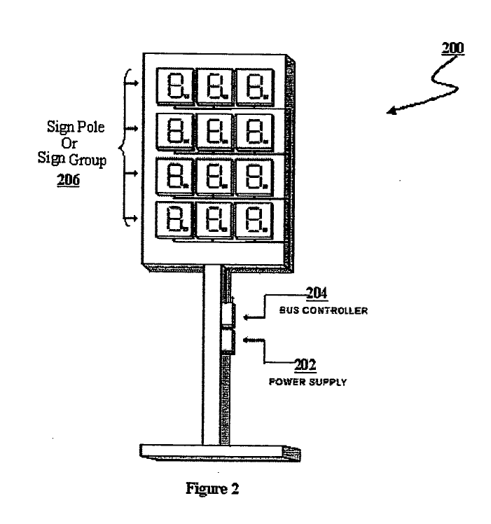

FIG. 2 shows an explicit embodiment 200 of the invention. The embodiment 200 comprises a power supply 202, bus controller 204 and sign pole with four sign groups, also described herein as a sign group 206. The user interface (not shown) is used to send an input value (price, number, etc.) from the user to the correct sign group 206 . A sign group 206 consists of LCD panel modules located on a sign pole. A sign group 206 can have a three digit value (1.50, 0.45, all blanks, etc.) sent to it from the user interface. The user interface allows the user to select the sign group 206 to which they would like to send the three digit value. To send a three digit value to a sign group, the user first selects the desired sign group by using the up (▴) and down (▾) keys on the user interface. The user would then enter the first digit by pressing a number key from 0 through 9. The user interface automatically inserts a decimal point after the user enters the first digit. The user could then enter two more digits to complete the three digit value. The user would then press the (SND) key to send the value to the sign group 206. The user interface will display a “SENDING . . . ▪” message on the screen to indicate that it is transmitting the value to the sign group 206.

The user interface allows the user to clear a value displayed on a sign group 206. The user would select the desired sign group by using the up (▴) and down (▾) keys and then without entering any digits, the user would press the (SND) key. This sends all blank values to the selected sign group 206.

The bus controller functions as the receiver of data sent from the user interface. The bus controller 204 also functions as the data transmitter for the LCD controllers. When the user interface sends a data packet, the bus controller 204 receives the data, formats the data, and transmits the formatted data to the LCD controllers. The bus controller 204 has an address associated with it in order to receive specific data packets from the user interface. The bus controller's 204 address is set through the use of a rotary binary coded decimal (BCD) switch and a three-pin jumper located on the circuit board. The bus controller's 204 address can be set to number zero through nine, using the first setting of the three-pin jumper. The second setting of the three-pin jumper allows the bus controller's address to be set to number ten through nineteen.

The bus controller 204 uses a four wire RS485 differential bus to send and receive data to and from the LCD controllers. When the user interface sends a data packet, the bus controller 204 will receive the data packet, check to see if the packet address matches the one set on the BCD switch, and then formats the data. The formatting of the data includes calculating the correct LCD controller addresses that make up a sign group 206 and assigning the display data to that LCD controller. When the data has been formatted, the bus controller 204 will send out the data packet on the RS485 bus and the addressed LCD controllers store the data. The bus controller 204 will then delay further transmissions for approximately one second. This provides for packet retransmission requests due to erroneous data and to allow the LCD controllers to format their data for display. After which, the bus controller 204 will send out a global command on the RS485 bus to indicate to the LCD controllers to send their display values to the display. This causes the three digit sign group value to appear to update simultaneously.

The LCD controller (not shown) functions as the sign panel controller 106 of FIG. 1. In the current system, the display element is a seven-segment LCD. The LCD controller receives its data from the bus controller 204. The data is received and transmitted on a differential RS485 bus. When the bus controller 204 sends a data packet, each LCD controller reads the data, determines if the sent address matches, and saves the data. The LCD controller will format the data to properly display on the seven-segment LCD and then save the data to the EEPROM. The LCD controller will then wait until the bus controller 204 sends a global command to retrieve the stored display data from the EEPROM. The data will then be used to energize the proper segments of the seven-segment LCD.

The LCD controller has circuitry for adjusting the contrast level of the seven-segment LCD. There are both manual and digital methods for contrast control. A three-pin jumper on the LCD controller circuit board determines whether the manual or automatic method of contrast control is used. A potentiometer located on the LCD controller circuit board provides contrast control through the use of a potentiometer. The user interface allows for contrast adjustment when the jumper is set for digital contrast control.

The LCD controller's address is set through the use of two rotary BCD switches and a three pin jumper located on the circuit board. The LCD controller's address can be set to a number one through ninety nine, using the first setting of the three-pin jumper. The second setting of the three-pin jumper allows the LCD controller's address to be set to number one hundred through one hundred and ninety nine.

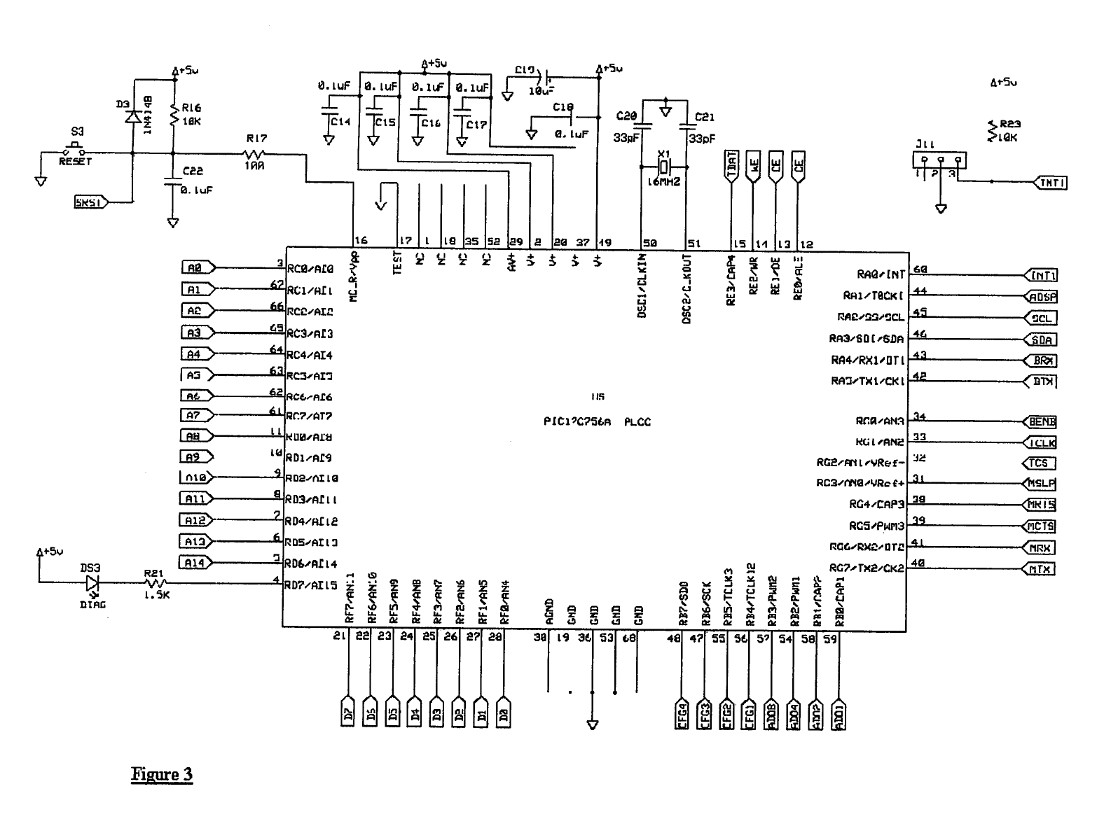

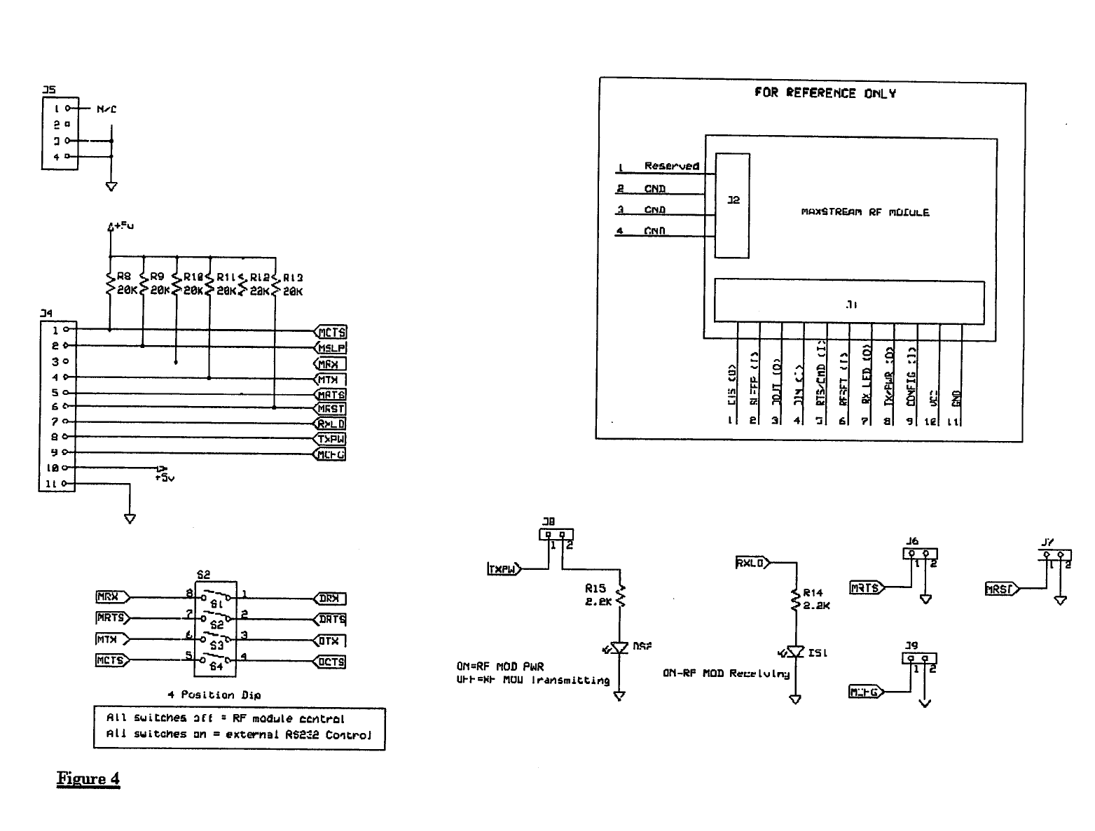

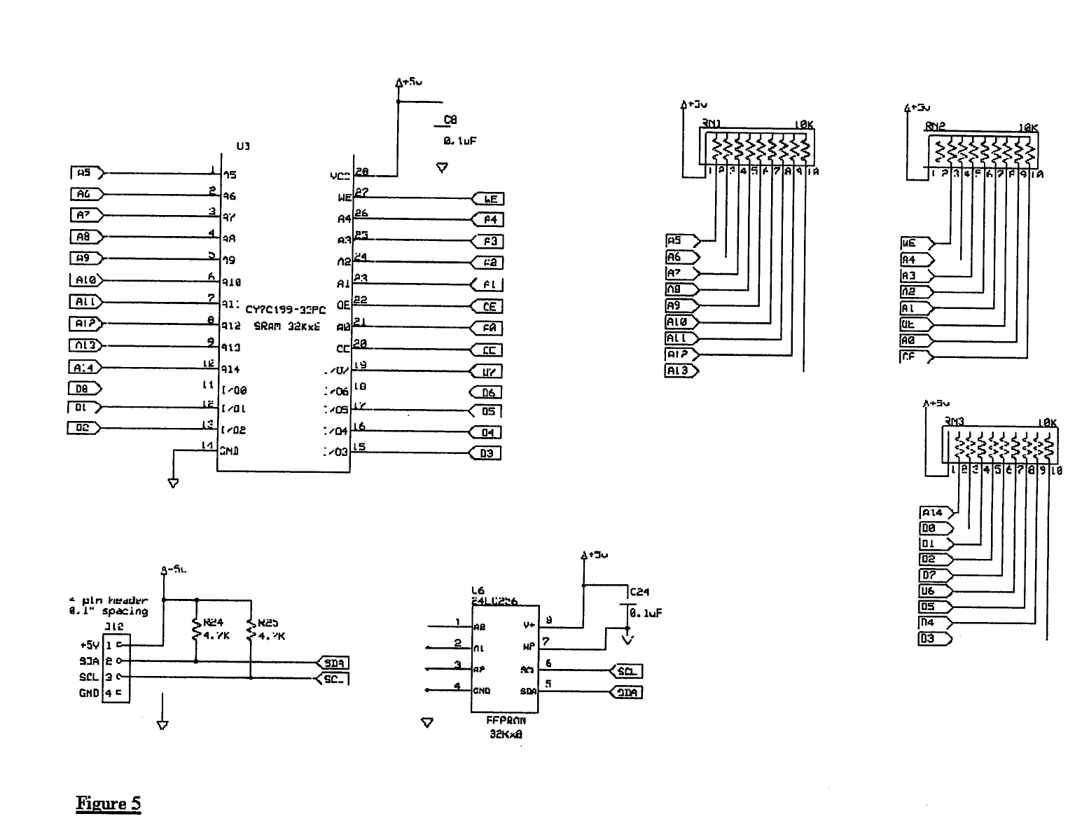

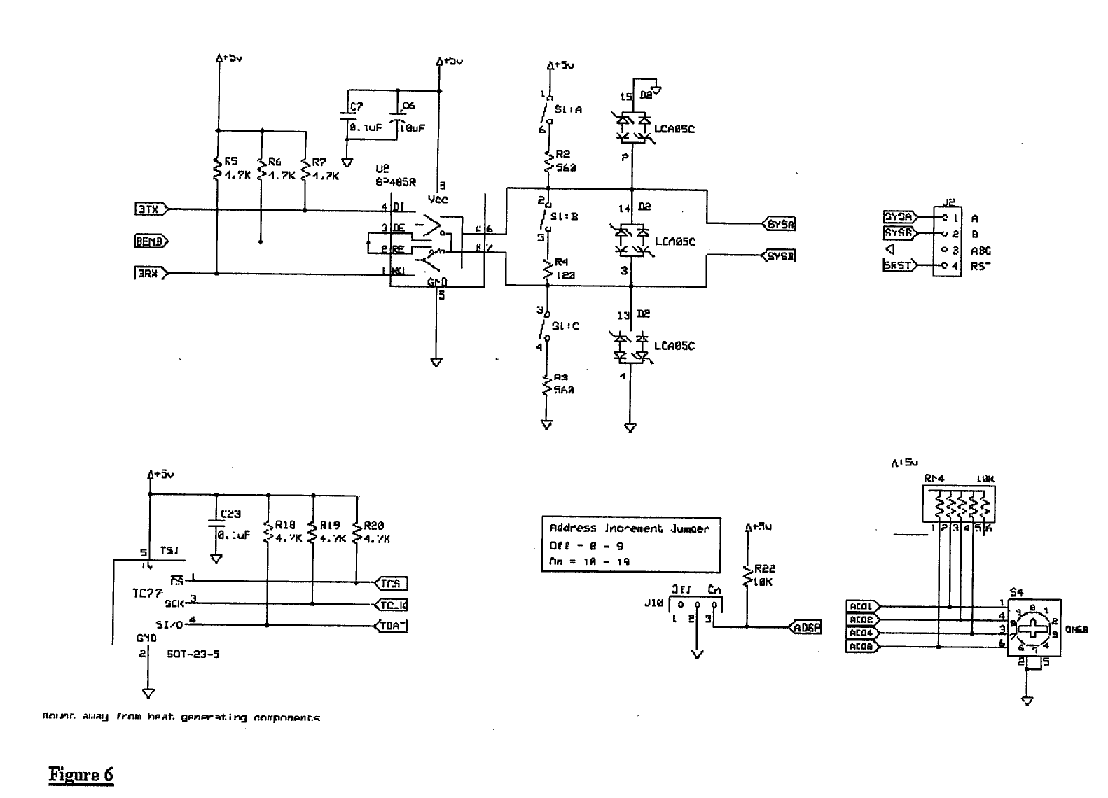

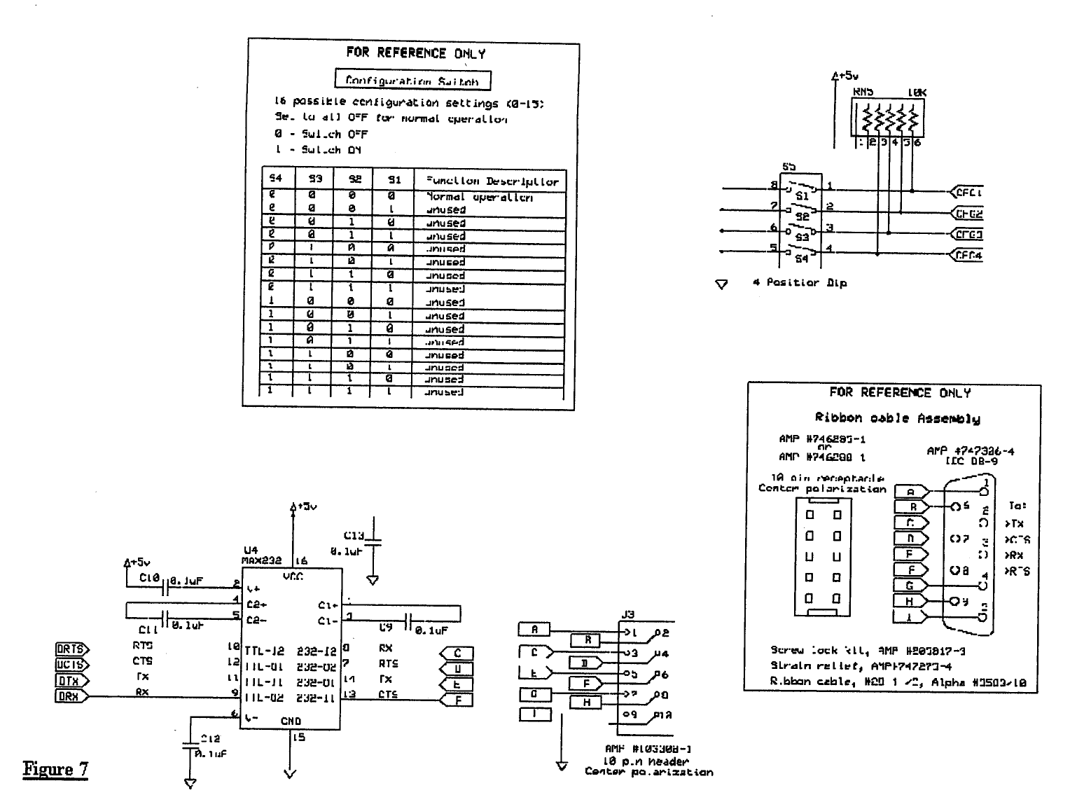

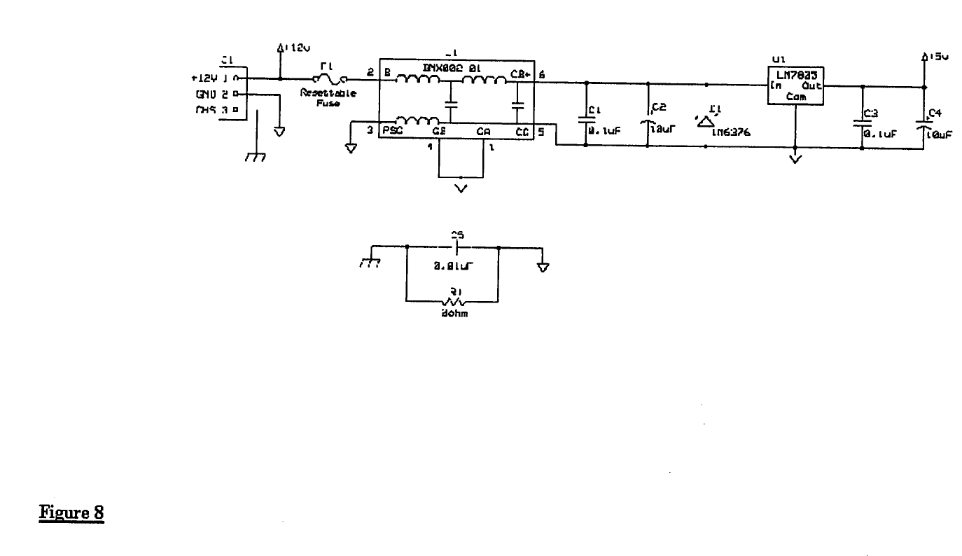

FIGS. 3 to 8 show one of the possible embodiments for bus controller incorporating a Microchip PIC17C756A PLCC.

It is to be understood that the invention is not limited to the specific features shown and described, since the means herein disclosed comprise preferred forms of putting the invention into effect, and that variations and modifications within the concepts of the invention can be made while remaining within the spirit and scope of the invention. The disclosures of the cited references and patents throughout the application are incorporated by reference herein.

What is claimed is:

1. A method for displaying messages on a display system comprising the steps of:
(a) providing one or more detachable interchangeable display panels comprising display elements capable of alpha-numeric or graphic displays, and operable to function independently;
(b) providing a logic circuit sandwiched in each display panel having memory;
(c) providing a controller connected to said logic circuit;
(d) receiving a first signal to said controller containing information to be displayed;
(e) identifying correctness of said first signal by said controller;
(f) requesting for resending said first signal if said first signal is identified incorrect;
(g) generating a second signal according to the information contained in said first signal using said controller;
(h) sending said second signal to said logic circuit;
(i) identifying correctness of said second signal by logic circuit;
(j) requesting for resending said second signal if said seconding signal is identified incorrect;
(k) storing a second signal responsible for display operation in the said memory of said logic circuit;
(l) identifying a display panel according to the stored signal; and
(m) switching said display element according to the stored second signal, thereby displaying desired information without essentially requiring real time communication.

2. A method for displaying messages on a display system according to claim 1, wherein the method comprises steps of providing array of display elements.

3. A method for displaying messages on a display system according to claim 1 wherein the step of displaying includes displaying message using liquid crystals, light emitting diodes, bi-stable technology and shutter elements.

4. A message display system comprising:
(a) at least one detachable interchangeable display panel capable of graphic displays, said display panel comprising display elements;
(b) a logic circuit sandwiched in each display panel having a memory capable of storing information to be displayed and for switching display elements for displaying information according to the stored information;
(c) a controller for receiving and examining a first signal containing information to be displayed and for generating a second signal in format readable to said logic circuit; and
(d) a communication means for communicating said second signal to said logic circuit and storing said signal in logic circuit memory thereby displaying a desired information without essentially requiring real time communication.

5. A message display system according to claim 4, wherein the system comprises signal elements organized in rows and columns.

6. A message display system according to claim 4, wherein said communication means is a data bus.

7. A message display system according to claim 4 wherein the display panel is selected from a group consisting of liquid crystals, light emitting diodes, bi-stable technology and shutter elements.

8. A message display system according to claim 4 wherein each display panel operates as a stand-alone display independent of a controller.

9. A message display system according to claim 4, wherein each display panel is programmable to display a preset routine.

10. A message display system according to claim 4, wherein when power is applied to the system, said display panel will display a routine without a controller or data bus.

11. A message display system according to claim 4, wherein each display panel comprises a programmable memory.

12. A message display system according to claim 4 wherein an input device communicates with a microprocessor, and said microprocessor converts input directions to a set of directions sent to each display panel.

13. A variable message display system comprising:
(a) a plurality of detachable interchangeable display panels capable of graphic displays, said display panel comprising display elements;
(b) a logic circuit sandwiched in each display panel having a memory capable of storing information to be displayed and for switching display elements for displaying information according to the stored information;
(c) a controller for receiving and examining a first signal containing information to be displayed and for generating a second signal in format readable to said logic circuit; and
(d) a communication means for communicating said second signal to said logic circuit and storing said signal in logic circuit memory thereby displaying a desired information without essentially requiring real time communication.

14. A variable message display system according to claim 13, wherein the system comprises signal elements organized in rows and columns.

15. A variable message display system according to claim 13, wherein said communication means is a data bus.

16. A variable message display system according to claim 13 wherein the display panel elements are selected from a group consisting of liquid crystals, light emitting diodes, bi-stable technology and shutter elements.

17. A variable message display system according to claim 13 wherein each display panel operates as a stand-alone display independent of a controller.

18. A variable message display system according to claim 13, wherein each display panel is programmable to display a preset routine.

19. A variable message display system according to claim 13, wherein when power is applied to the system, said display panel will display a routine without a controller or data bus.

20. A variable message display system according to claim 13, wherein each display panel comprises a programmable memory.

21. A variable message display system according to claim 13 wherein an input device communicates with a microprocessor, and said microprocessor converts input directions to a set of directions sent to each display panel.
